(19) United States
(12) Patent Application Publication
(10) Pub. No.: US 2006/0045540 A1
(43) Pub. Date: Mar. 2, 2006

(54) Optical signal selector

(75) Inventors: Takeshi Sato, Utsunomiya (JP); Nobuhiro Ueno, Oyama (JP)

Correspondence Address: SUGHRUE MION, PLLC, 2100 PENNSYLVANIA AVENUE, N.W., SUITE 800, WASHINGTON, DC, 20037, US

(73) Assignee: HITACHI METALS, LTD.

(21) Appl. No.: 11/207,788

(22) Filed: Aug. 22, 2005

(30) Foreign Application Priority Data
Aug. 30, 2004 (JP) 2004-250126

(51) Int. Cl. H04B 10/16

(52) U.S. Cl. 398/176

(57) ABSTRACT

In the fields of optical measurement and optical communications, in order to select one from among a number N of optical signal property conversion conditions, a number N of selection optical paths are provided within a signal transfer optical path extending from an input to an output by use of optical switches, whereby a desired optical signal property conversion is performed. An apparatus is an optical switching circuit in which one optical signal input is branched into a number N of selection optical paths by use of optical switches, and a number N of selection optical paths are output as one optical signal by use of optical switches, wherein at least one or more devices for converting optical signal property are inserted into a number N of selection optical paths, whereby it is possible to select one from among a number N of optical signal property conversion conditions under the control of the optical switches.

### BACKGROUND OF THE INVENTION

1. Field of the Invention

The present invention relates to an optical signal selector which generates optical signals having various properties for use in the field of optical measurement or in the field of optical communications.

2. Description of the Related Art

In the fields of optical measurement and optical communications, it is necessary experimentally and commercially to create artificially optical signals having various properties, such as multiple levels of optical signal intensity and multiple levels of signal transmission state, to thereby evaluate an optical measurement device or optical communications device.

For example, in the evaluation of an optical intensity sensor, it is necessary to vary the optical intensity of an input signal in multiple levels and measure the output of the optical intensity sensor for each of the multiple levels of optical intensity. In optical communications, in order to evaluate the waveform degradation state of a digital signal propagating within an optical fiber and the reproduction performance in the receiver side, an optical digital signal having the waveform degradation thereof varied in multiple levels is got through the optical fiber, and the received signal and reproduction state are evaluated.

In these measurements, an input light having various properties must be supplied to a device to be measured (measurement object). An optical signal source generates an optical signal having a specific property; therefore, in order to supply to a device to be measured, an optical signal having properties required for the measurement, there are prepared many optical signal sources for generating optical signals having various properties which cover the required property range, and these optical signals are successively supplied to the device to be measured one by one. Alternatively, a device capable of varying successively the state of optical signal is inserted between an optical signal source and measurement object.

For example, as shown in FIG. 7 illustrating a conventional measurement method, when three levels (A), (B) and (C) of optical signal intensity are required, three optical signal sources 20a, 20b and 20c are prepared which generate optical signals each having the respective levels (A), (B) and (C) of optical signal intensity, and these optical signal sources are connected to a measurement object 14 as required, whereby the measurement is performed with a monitor 40. Specifically, optical connectors 28a, 28b and 28c of the optical signal sources 20a, 20b and 20c are connected successively to an optical connector 29 of the measurement object 14, and optical signals each having a different intensity is supplied to the measurement object 14, whereby the measurement is performed with the monitor 40 to evaluate the measurement object 14.

In FIG. 8, there is shown an exemplary device connection in which signal intensity is varied with a single signal source. An optical signal source 20, variable optical signal intensity attenuator 25, measurement object 14 and monitor 40 are connected to each other. A light having a given intensity is generated by the optical signal source 20, and the signal intensity thereof is adjusted by the variable optical signal intensity attenuator 25 to vary the signal intensity, and the measurement is performed with the monitor 40 to evaluate the measurement object 14.

In recent years, in order to cope with the explosive increase of the number of Internet users and the ever increasing communication data, communications lines have been increasingly made an optical fiber, and optical fibers have been laid up to each household at tail end. In laying an optical fiber, in order to examine the optical transmission performance of the optical fiber after laying the optical fiber, optical signals are actually got through the optical fiber for confirmation. An example of this confirmation operation is shown in FIG. 9. To the upstream entrance of a laid optical fiber being a measurement object 14, there are connected an optical signal source 20 and variable optical signal intensity attenuator 25; to the downstream exit thereof, there is connected a monitor 40 for measuring the signal intensity. In the confirmation operation, multiple optical signal intensities are required. Thus, in the upstream entrance, an operator 17 adjusts the variable optical signal intensity attenuator 25 to vary the optical signal intensity; in the downstream exit, an operator 18 performs the measurement. The adjustment of the variable optical signal intensity attenuator in the upstream entrance must be synchronized with the measurement in the downstream exit, so the operators 17 and 18 communicates with each other by use of a conversation line 15 to perform this confirmation operation. In the operator 17 side, in addition to the optical signal source 20 and variable optical signal intensity attenuator 25 for creating multiple optical signal intensities, a system for controlling the variable optical signal intensity attenuator, a power supply thereof, a device for measuring the intensity of output light of the variable optical signal intensity attenuator are required (not shown). Optical fibers for connecting these devices are also laid here and there, so a broad operation space is required.

It is economically burdensome to prepare many signal sources for generating various kinds of optical signals required for testing a measurement object such as an optical property measurement device and optical signal propagation path. Many signal sources are successively connected to the measurement object to test the measurement object; therefore, it takes time to perform the switchover required. Also, when a signal source is replaced with another signal source to be connected to the measurement object, optical property can change due to this same connection, thus making it impossible to obtain a stable optical signal. Further, if the signal property of the signal source cannot be adjusted, any requirement other than the prepared signal property cannot be met. Consequently, there is desired a low-cost optical signal supplying apparatus which can easily select one from among multiple signal property levels and whose optical signal property is stable.

When an optical property converter capable of varying successively the optical signal property is employed as the optical signal supplying apparatus, the optical signal property can be set in a wide range, and further the operation of connecting many signal sources successively to the measurement object can be eliminated. However, in order to set an optical signal to a specific property, it is necessary to adjust the optical property converter and confirm the output of the converter. Also, in an optical property converter capable of varying successively the signal property, even when the output signal is held at a given property, the output is monitored, and the output thus detected is compared with a desired output value to adjust the converter; specifically, a feedback control is performed, so the supply of electrical power is needed at all times.

As shown in FIG. 9, in the confirmation operation performed after laying the optical fiber, the operators 17 and 18 at a long distance from each other at both ends of the laid optical fiber (measurement object 14) vary/select the properties such as the optical signal intensity while communicating with each other via the conversation line 15; this operation is not efficient. It is also needed to prepare, install and adjust the equipment, and further to lay temporarily on the site, optical fibers used in the test, so a broad operation space is required. In many cases, however, it is difficult to secure a floor space required for the operation on the site.

### SUMMARY OF THE INVENTION

An object of the present invention is to provide an optical signal selector capable of generating selectively optical signals having various properties for use in the evaluation or test of a measurement object such as an optical signal intensity sensor and other optical property measurement devices, and a laid optical signal propagation path.

An optical signal selector according to the present invention includes: an optical signal property conversion section which has multiple devices for converting optical signal property; an optical signal selection branch section which has an input port for receiving an optical signal and optical switches for connecting the input port selectively to the multiple devices for converting optical signal property in the optical signal property conversion section; and an optical signal selection output section which has an output port of optical signal and optical switches for connecting the output port of optical signal selectively to the multiple devices for converting optical signal property in the optical signal conversion section. Each of the multiple devices for converting optical signal property in the optical signal property conversion section outputs an optical signal having a respective level from among multiple levels of the optical signal property, or outputs an optical signal having a respective level from among multiple levels with respect to multiple kinds of optical signal properties.

Preferably the optical signal selector according to the present invention further includes a controller which selects at least one device from among the multiple devices for converting optical signal property in the optical signal property conversion section, causes the optical switches in the optical signal selection branch section to connect the input port for receiving an optical signal to the selected device, and causes the optical switches in the optical signal selection output section to connect the selected device to the output port of optical signal.

More preferably the controller can be operated locally and remotely.

Preferably the optical signal selection branch section and optical signal selection output section each has multiple 1×2 type optical switches. More preferably the 1×2 type optical switch is of the optical path self-holding type.

Preferably the multiple devices for converting optical signal property contained in the optical signal selector of the present invention each convert at least one kind of optical signal property selected from the group of consisting of attenuation of intensity, amplification of intensity, conversion of polarization, conversion of wavelength, degradation of waveform, shaping of waveform, modulation, multiplexing and delaying of an optical signal.

The optical signal selector of the present invention can supply to a measurement object, many optical signals having various properties required for the evaluation test of the measurement object by being connected to a single optical signal source generating an optical signal having a given property.

An optical switch is used to select one from among many devices for converting optical signal property. Thus the change of optical path can be performed rapidly in 10 msec or less. When multiple stages of 1×2 type switches are used as the optical switch, multiple optical switches connected to each other in multiple stages can be simultaneously activated during a time period when one optical switch is activated. Thus, the drive time period for all the multiple-stage optical switches can be shortened to the activation time period of one optical switch. Also, the 1×2 type mechanical switch is of the self-holding type, so a supply of energy is not required to hold an optical path.

In the optical signal selector of the present invention further including the controller which selects one from among multiple devices for converting optical signal property in the optical signal property conversion section, connects the one selected device to the input port by the optical switch, connected to the optical signal source, for receiving an optical signal by the optical switch, and connects the one selected device to the output port of optical signal, one device can be selected from among multiple devices in the optical signal property conversion section by use of the controller, and the input port and output port can be connected to the selected device by use of the controller. Accordingly, an optical signal having a desired property can be supplied to a measurement object so that the evaluation of the measurement object can be easily performed. Further, when the controller can be operated locally and remotely, a measurement object, such as an optical signal propagation path with both ends thereof at a long distance from each other, can also be tested easily.

### BRIEF DESCRIPTION OF THE DRAWINGS

FIG. 1 is a block diagram showing an optical signal selector according to Embodiment 1 of the present invention;

FIG. 2 is a block diagram showing an optical signal selector according to Embodiment 2 of the present invention;

FIG. 3 is a block diagram showing an optical signal selector according to Embodiment 3 of the present invention;

FIG. 4 is a block diagram showing an optical signal selector according to Embodiment 4 of the present invention;

FIG. 5 is a block diagram showing an optical signal selector according to Embodiment 5 of the present invention;

FIG. 6 is a view explaining an operation of confirming a measurement object by use of a remotely operable optical signal selector according to Embodiment 1 of the present invention;

FIG. 7 is a view explaining a conventional operation of confirming a measurement object;

FIG. 8 is a view explaining an example of a device connection in which signal intensity is varied with a single signal source; and

FIG. 9 is a view explaining a conventional confirmation operation after laying an optical fiber.

### DETAILED DESCRIPTION OF THE PREFERRED EMBODIMENTS

Embodiments of the present invention will be described below in detail with reference to the drawings. To make the description easy to understand, the same reference numerals are applied to identical components and parts.

### EXAMPLE 1

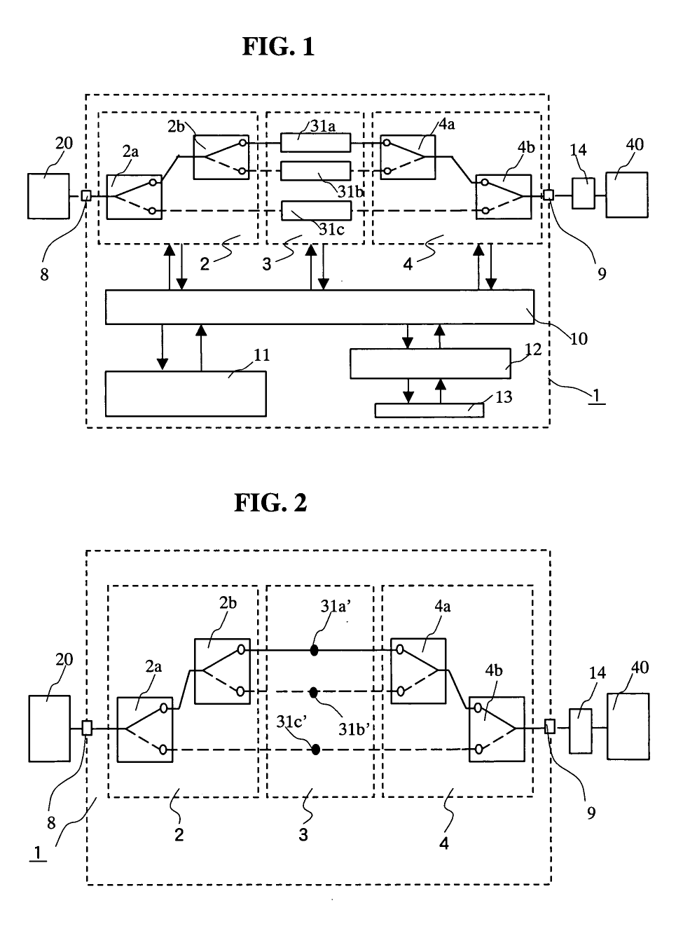

FIG. 1 is a block diagram for evaluating an optical signal amplifier (measurement object 14) by use of an optical signal selector 1 according to Embodiment 1 of the present invention. The optical signal selector 1 has an input port 8 of optical signal and an output port 9 of optical signal. The measurement object 14 is connected to the output port 9 of the optical signal selector 1, and further a monitor 40 is connected to the measurement object in order to measure the output of the measurement object 14. An optical signal source 20 is connected to the input port 8 of the optical signal selector 1.

In order to evaluate the optical signal amplifier, the relationship between the output and input of the optical signal amplifier must be determined by varying the input optical signal intensity in two levels or more. The optical signal output of the one signal source has a certain level of intensity; the optical signal output of the optical signal source is attenuated in three levels in the optical signal selector 1; each of the three levels of optical signal thus attenuated are successively supplied to the measurement object 14.

The optical signal selector 1 includes: an optical signal property conversion section 3 which has as the device for converting optical signal property, three attenuators 31a, 31b and 31c attenuating optical signal intensity; an optical signal selection branch section 2 which has optical switches connecting the input port 8 selectively to the three attenuators 31a, 31b and 31c; and an optical signal selection output section 4 which has optical switches connecting the output port 9 selectively to the three attenuators 31a, 31b and 31c. The bend loss of an optical fiber is utilized in the attenuators 31a, 31b and 31c; by adjusting the curvature radius and the number of turns of a curved optical fiber, the optical attenuation of the attenuators 31a, 31b and 31c are set to 1 dB, 3 dB and 10 dB, respectively. The optical signal selection branch section 2 with 1×2 type optical switches 2a and 2b selects one from among the attenuators 31a, 31b and 31c, and connects a signal supplied to the input port 8 to the selected attenuator (31a, 31b and 31c). The optical signal output selection section 4 with 1×2 type optical switches 4a and 4b selects one from among the attenuators 31a, 31b and 31c, and connects the selected attenuator to the output port 9.

One attenuator is selected from among the three attenuators in the optical signal property conversion section 3, and the selected attenuator is connected to the input port 8 by use of the two 1×2 type optical switches 2a and 2b in the optical signal selection branch section 2, and the selected attenuator is connected to the output port 9 by use of the two 1×2 type optical switches 4a and 4b in the optical signal selection output section 4. The above connections are implemented by the controller 10.

The controller 10 has a circuit which selects and drives an optical signal property converter (an attenuator in the present embodiment), a circuit which drives the optical switches in the optical signal selection branch section and optical signal selection output section, and a circuit which detects the position of the optical switches. With the controller 10, the optical path of the optical switches 2a and 2b and the optical switches 4a and 4b can be changed in a desired order to select one from among the attenuators 31a, 31b and 31c, whereby the intensity of optical signal sent from the optical signal source 20 to the measurement object 14 can be varied. The controller 10 is connected to a console 11. The console 11 has: a display unit which displays the operating state of each converter in the optical signal property conversion section and the connection state of optical path in the optical signal selection branch section and optical signal selection output section; and an operation unit for changing manually the optical path. With the operation unit, the optical path of the optical switches 2a and 2b and the optical switches 4a and 4b can be changed manually or in a predetermined order. In the display unit, the connection state of optical path can be confirmed from the glow of pilot lamps, or displayed by a CRT. Further, the controller 10 can be connected to an optical path change remote operation unit 12. The remote operation unit 12 sends an optical path change instruction to the controller 10 based on a signal from the outside, and at the same time acquires the connection state of optical path, having a function of a server with respect to an interface. The server has a unique IP address; at the same time, a remote operation interface 13 is set as the 100BASE-T LAN interface. This LAN interface is connected to the Internet, whereby the optical signal selector of the present invention can be controlled from a remote site.

Note that the remote operation interface 13 is not limited to the above described LAN interface; various wired as well as wireless interfaces, such as RS 232C, IEEE 1394 and USB, can be employed. When multiple interfaces described above are installed in the optical signal selector, the cost of the apparatus itself will be increased. In this case, however, the scope of interface selection is expanded, whereby usability is improved significantly.

With the optical signal selector of the present invention, the intensity of optical signal supplied to a measurement object can be varied without canceling the connection between an optical signal source 20 and measurement object 14. Also, since the connection is implemented by the optical switches, an optical signal having a stable intensity can be supplied.

The optical switch used in Embodiment 1 is of the 1×2 type; with one input optical path and two output optical paths, an optical path can be selected from among the two output optical paths; or with two input optical paths and one output optical path, an optical path can be selected from among the two input optical paths. The 1×2 type optical switch has a short optical path change time period of 10 msec or less, so the drive time period is short. As the 1×2 type optical switch, it is preferred to employ a so-called self-holding type optical switch which changes the optical path by electromagnetic force and holds the connected optical path by the suction force of a permanent magnet; examples of such optical switch include one disclosed in U.S. Pat. No. 6,169,826 (issued on Jan. 2, 2001), or in U.S. Pat. No. 6,836,586 (issued on Dec. 28, 2004).

In Embodiment 1, three attenuators having a different attenuation coefficient from each other are used in the optical signal property change section. Thus, in the optical signal selection branch section, there are used two 1×2 type optical switches; one input optical path from the input port is connected to each attenuator via three output optical paths. In the optical signal selection output section, there are used two 1×2 type optical switches; three input optical paths are connected to one output optical path, whereby one attenuator is selected from among the three attenuators and connected to the output port.

According to the present invention, the number of attenuators used in the optical signal selector of Embodiment 1 can be increased, and the number of 1×2 type optical switches used therein can be increased. Alternatively, there can be used a 1×N type optical switch in which the number N of output optical paths is larger than two. Also, as the attenuator, there can be used one whose attenuation coefficient is fixed or semi-fixed (in this case, attenuation coefficient can be adjusted in a small range). For example, in the attenuator used in Embodiment 1 which utilizes the bend loss of an optical fiber, attenuation coefficient can be adjusted in a small range by varying the curvature radius while the number of turns is fixed.

In Embodiment 1, in order to generate three kinds of optical signals having a different intensity from each other for use in the evaluation of an optical signal intensity sensor, the optical signal selector includes the optical signal attenuators working as a device for converting optical signal property. In addition to intensity, an optical signal has properties such as polarization, wavelength, waveform, multiplexing and delaying. Accordingly, the optical signal property must be changed according to the optical signal source and measurement object to be evaluated. According to the optical signal source, the kind of measurement object, and the item of evaluation, the optical signal selector of the present invention can include an optical signal property converter which changes at least one selected from among attenuation of intensity, amplification of intensity, conversion of polarization, selection of wavelength, conversion of wavelength, degradation or blunting of waveform, shaping of waveform, modulation, multiplexing and delaying of an optical signal. TABLE 1 shows a summary of these optical signal property conversions.

TABLE 1

| Item | Contents | Method of conversion |
|---|---|---|
| Attenuation of | Reduce optical intensity | Decrease optical intensity by using an |
| intensity | | optical attenuator |
| Amplification of | Amplify optical intensity | Raise optical intensity by using an |
| intensity | | optical amplifier |
| Change of | Create a polarized wave | Create a polarized wave by using a |
| polarization | | polarizer or by applying stress, such |
| | | as a twist, to a fiber |
| Selection of | Demultiplex a | Demultiplex a multiplexed signal by |
| wavelength | wavelength-division | using an optical DEMUX circuit |
| | multiplexed signal | (wavelength selection optical filter) |
| Conversion of | Conversion to another | Vary the wavelength of an optical |
| wavelength | wavelength | signal by using a wavelength |
| | | converter and converting the signal |
| | | from optical to electrical to optical |
| | | form |
| Blunting of | Vary the phase of waveform of | Vary the phase of a signal by using a |
| waveform | a pulse signal | phase dispersion unit or by converting |
| (Degradation of | | the signal from optical to electrical to |
| waveform) | | optical form |
| Shaping of | Restore a dull waveform to a | Shape a waveform by using a |
| waveform | satisfactory pulse waveform | dispersion compensator or by |
| | | converting a signal from optical to |
| | | electrical to optical form |
| Modulation | Modulate an input signal by a | Perform modulation by converting the |
| | burst etc. | signal from optical to electrical to |
| | | optical form |
| Multiplexing | Combine an input signal with | Perform multiplexing by using an |
| | another signal | optical MUX circuit |
| Delaying | Delay a predetermined signal | Delay a signal by using a delay |
| | before transmitting it | phenomenon associated with fiber |
| | | transmission or by using a delay |
| | | circuit. |

### EXAMPLE 2

FIG. 2 shows a block diagram for evaluating an optical signal amplifier (measurement object 14) by use of an optical signal selector 1 according to Embodiment 2. Instead of the attenuators 31a, 31b and 31c, used in the optical signal selector of Embodiment 1, which utilizes the bend loss of an optical fiber, offset fusion connection points 31a′, 31b′ and 31c′ of optical fiber are used herein. In the offset fusion connection point, two optical fibers are connected by fusion with the central axis of the core thereof deflected; an optical signal is attenuated by the loss of optical intensity caused by the deflection of the central axis of an optical fiber core. An attenuation value is set by the offset fusion connection, so the attenuation value is fixed. However, the size and cost of the optical signal selector can be reduced.

### EXAMPLE 3

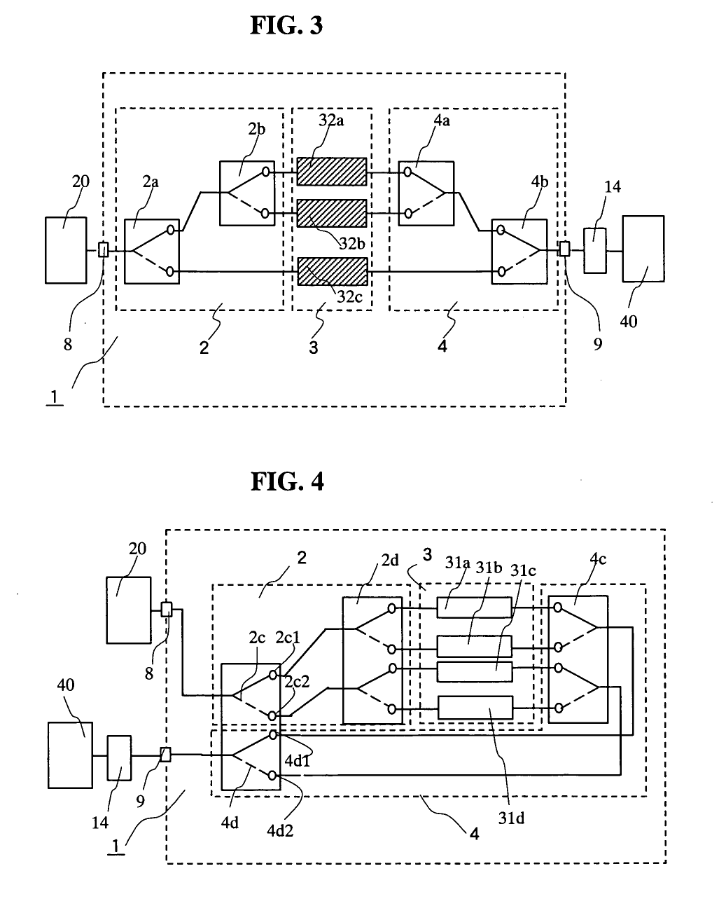

FIG. 3 shows a block diagram for evaluating a dispersion phase compensator by use of an optical signal selector 1 according to Embodiment 3. In evaluating a dispersion phase compensator, three kinds of optical signals having a different degradation state (blunting state), i.e., a different phase shifting must be supplied to the dispersion phase compensator; the shifted phases are restored within the dispersion phase compensator, and it is monitored how much the original phase is restored. The optical signal selector 1 includes: an optical signal property conversion section 3 which has three phase dispersion units 32a, 32b and 32c changing the optical signal degradation state; an optical signal selection branch section 2 which has optical switches 2a and 2b connecting an input port 8 selectively to the three phase dispersion units 32a, 32b and 32c; and an optical signal selection output section 4 which has optical switches 4a and 4b connecting an output port 9 selectively to the three phase dispersion units 32a, 32b and 32c. The phase dispersion units 32a, 32b and 32c convert an optical signal to an electrical signal and further convert the electrical signal to an optical signal, and the rise and descending of the digital optical signal are shifted or the period thereof is varied while the frequency of the optical signal is maintained. When an optical signal outputted from an optical signal source 20 is passed through the input port 8 and subjected to the degradation process in the phase dispersion units 32a, 32b and 32c of the optical signal property conversion section 3, the outputs of the phase dispersion units have a phase shift of, for example, +θ, −θ and +θ′, respectively. The optical signal selection branch section 2 and optical signal selection output section 4 of the present embodiment have the same configuration as those used in Embodiments 1 and 2.

The optical signal selector 1 of Embodiment 3 is driven by a controller similarly to FIG. 1. The three phase dispersion units 32a, 32b and 32c are connected in a predetermined order to a measurement object 14, i.e., a dispersion phase compensator via the output port 9, whereby three kinds of optical signals having a different degradation state from each other are supplied to the dispersion phase compensator, and the extent of phase correction by the dispersion phase compensator is measured by use of a monitor 40.

### EXAMPLE 4

FIG. 4 shows a block diagram for evaluating a measurement object 14 by use of an optical signal selector 1 according to Embodiment 4. In the present embodiment, as devices for converting optical signal property, an optical signal property conversion section 3 has four attenuators 31a, 31b, 31c and 31d attenuating optical signal intensity. In order to connect an input port 8 selectively to the four attenuators 31a, 31b, 31c and 31d, an optical signal selection branch section 2 is constituted of a 1×2 type optical switch 2c, which is one part of a 2×4 type optical switch, and a 2×4 type optical switch 2d. In order to connect an output port 9 selectively to the four attenuators 31a, 31b, 31c and 31d, an optical signal selection output section 4 is constituted of a 2×4 type optical switch 4c and a 1×2 type optical switch 4d, which is another part of the 2×4 type optical switch. The two 1×2 type optical switches contained in the three 2×4 type optical switches used herein work with each other. For example, the two 1×2 type optical switches 2c and 4d contained in the 2×4 type optical switch are driven simultaneously; when one 1×2 type optical switch 2c selects the 2c1 side, the other 1×2 type optical switch 4d selects the 4d1 side. Also, when the 1×2 type optical switch 2c selects the 2c2 side, the other 1×2 type optical switch 4d selects the 4d2 side. Further, the three 2×4 type optical switches can be driven simultaneously. When the three 2×4 type optical switches are made to work with each other, an optical switch drive circuit contained in a controller for driving the optical signal selector 1 can have a simple configuration. Also, in an optical signal selector using 2×4 type optical switches, the number of components can be reduced compared to when 1×2 type optical switches are separately used.

### EXAMPLE 5

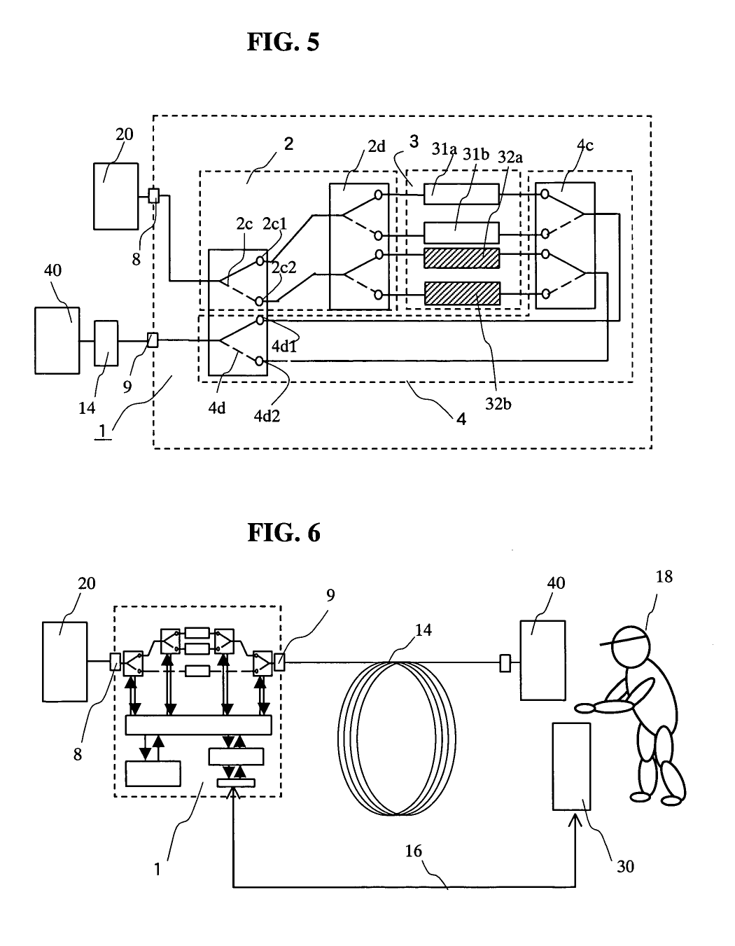

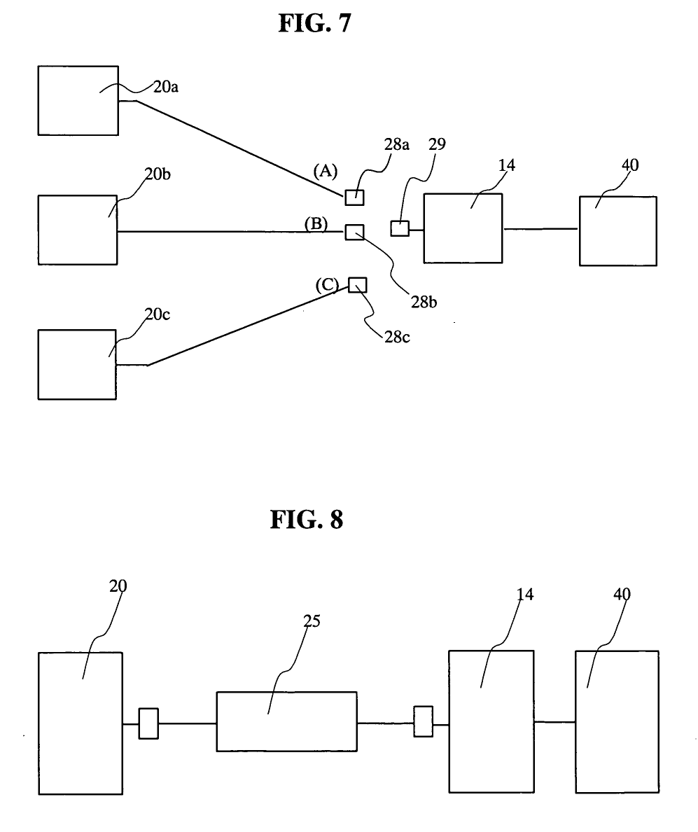

FIG. 5 shows a block diagram for evaluating a measurement object 14 by use of an optical signal selector 1 according to Embodiment 5. In the present embodiment, as devices for converting optical signal property, an optical signal property conversion section 3 has two attenuators 31a and 31b attenuating optical signal intensity and two phase dispersion units 32a and 32b varying the degradation state of an optical signal. The optical signal selection branch section 2 and optical signal selection output section 4 of the present embodiment have the same configuration as one used in Embodiment 4. By using this optical signal selector 1, two kinds of optical signals having a different optical signal intensity and two kinds of optical signals having a different degradation state are supplied to a measurement object 14 in a predetermined order, whereby the evaluation of the measurement object 14 can be performed by use of a monitor 40.

As a variation of the present embodiment, there can also be realized an optical signal selector including: an optical signal property conversion section having four optical signal attenuators, four phase dispersion units, four polarization changing units, and four wavelength converters; an optical signal selection branch section which connects an input port selectively to these sixteen optical signal property converters; and an optical signal selection output section which connects an output port selectively to these sixteen optical signal property converters. In the optical signal selector according to this variation, each of the four kinds of optical signal properties can be varied in four levels, thus significantly improving the convenience.

### EXAMPLE 6

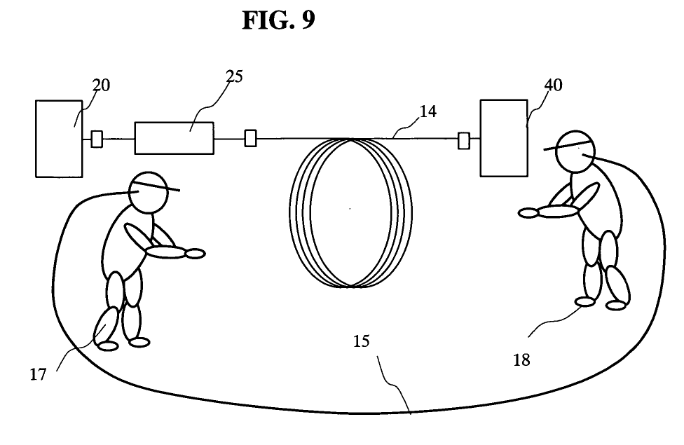

FIG. 6 is a view explaining a confirmation operation after laying an optical fiber by use of a remotely operable optical signal selector 1 described in Embodiment 1. As described in FIG. 9, in a conventional confirmation operation after laying an optical fiber, the optical signal source 20, variable optical signal intensity attenuator 25, and operator manipulating these devices are required at one end of the laid optical fiber being the measurement object 14, and the monitor 40 and another operator are required at the other end of the laid optical fiber. The two operators perform the operation while communicating with each other. When a remotely operable optical signal selector 1 of the present invention is used, an operator 18 operates a remote operation apparatus 30 connected to an optical signal selector 1 disposed in the vicinity of an optical signal source 20 of the laid optical fiber 14 via a remote communication line and selects one from among an optical signal selection branch section, optical signal property conversion section, and optical signal selection output section, whereby an optical signal required for the confirmation operation after a laying operation is sent to a monitor 40 via the laid optical fiber being a measurement object 14. The operator can perceive the state of the laid optical fiber 14 from a measurement value obtained from a monitor 40. In performing a confirmation operation after laying an optical fiber, after the optical signal source 20 and remotely operable optical signal selector 1 are connected to the laid optical fiber being the measurement object 14, the operator need not to be present at the site; the operator can perform the operation alone in the monitor 40 side.

The dimensions of the optical signal selector 1 of the present invention provided with the function and configuration described in the above embodiment are about 250 mm wide by 90 mm high by 300 mm thick. The floor space is about one-tenth compared to a conventional case where single devices are combined, because wiring etc. of optical fibers are significantly reduced, whereby the confirmation operation after laying an optical fiber can be performed at any operation site.

The embodiments of the optical signal selector of the present invention were described in detail. However, the optical path connection method, optical signal property conversion method, and the number N of conditions are not limited thereto. Also, as the optical switch, 1×2 type switches and 2×4 type switches can be used in a mixed manner, and other optical switches which can rapidly change an optical path can also be used. As the optical signal property conversion device installed in the optical signal selector, according to the kind of an optical signal source and the kind of a measurement object to be evaluated, it is possible to use various devices which have functions of attenuation of intensity, amplification of intensity, conversion of polarization, selection of wavelength, conversion of wavelength, degradation (blunting) of waveform, shaping of waveform, modulation, multiplexing and delaying of an optical signal.

What is claimed is:

1. An optical signal selector comprising:
an optical signal property conversion section which has a plurality of devices for converting optical signal property;
an optical signal selection branch section which has an input port for receiving an optical signal and optical switches for connecting the input port selectively to the plurality of devices for converting optical signal property in the optical signal property conversion section; and
an optical signal selection output section which has an output port of optical signal and optical switches for connecting the output port of optical signal selectively to the plurality of devices for converting optical signal property in the optical signal property conversion section.

2. The optical signal selector according to claim 1, further comprising a controller which selects at least one device from among the plurality of devices for converting optical signal property in the optical signal property conversion section, causes the optical switches in the optical signal selection branch section to connect the input port for receiving an optical signal to the selected device, and causes the optical switches in the optical signal selection output section to connect the selected device to the output port of optical signal.

3. The optical signal selector according to claim 2, wherein the controller can be operated locally and remotely.

4. The optical signal selector according to claim 2, wherein the optical signal selection branch section and optical signal selection output section each has a plurality of 1×2 type optical switches.

5. The optical signal selector according to claim 4, wherein the plurality of 1×2 type optical switches are of the optical path self-holding type.

6. The optical signal selector according to claim 1, wherein the plurality of devices for converting optical signal property convert at least one kind of optical signal property selected from the group of consisting of attenuation of intensity, amplification of intensity, conversion of polarization, conversion of wavelength, degradation of waveform, shaping of waveform, modulation, multiplexing and delaying of an optical signal.
